(19) United States
(12) Patent Application Publication
(10) Pub. No.: US 2011/0160379 A1
(43) Pub. Date: Jun. 30, 2011

(54) COATING COMPOSITION TO OBTAIN SURFACE EFFECTS

(76) Inventors: GABRIELE BUETTNER, (US); Matthieu Barrere, (US); Joern Vestweber, (US)

(21) Appl. No.: 12/940,404

(22) Filed: Nov. 5, 2010

Related U.S. Application Data
(60) Provisional application No. 61/291,122, filed on Dec. 30, 2009.

(51) Int. Cl. C09D 175/04

(52) U.S. Cl. 524/507

(57) ABSTRACT

This invention provides a coating composition providing a soft-feel effect and enhanced suntan cream resistance, the composition comprising
A) 5 to 50 wt %, preferably 20 to 40 wt %, of an dispersion and/or solution of at least one hydroxyl functional polyurethane, the dispersion and/or solution having a solids content in a range of 25 to 90 wt %, the wt % being based on the weight of the dispersion and/or solution,
B) 0 to 35 wt %, preferably 5 to 20 wt %, of at least one polyisocyanate as cross-linking agent,
C) 0.1 to 20 wt %, preferably 4 to 15 wt %, of at least one aqueous hydroxyl functional crosslinked (meth) acrylic latex,
D) 0 to 20 wt %, preferably 4 to 15 wt %, of organic solvent, and
E) 0.1 to 10 wt %, preferably 4 to 10 wt %, of at least one pigment, extender and/or coating additive,
the wt % being based on the total weight of the composition of A) to E).

### CROSS-REFERENCE TO RELATED APPLICATION

This application claims the benefit of U.S. Provisional Application Ser. No. 61/291,122 filed on Dec. 30, 2009 which is hereby incorporated by reference.

### FIELD OF THE INVENTION

The invention relates to a coating composition providing a soft-feel effect and enhanced resistance to suntan creams or lotions of the coated substrates.

### BACKGROUND OF THE INVENTION

To improve the haptic quality (touch feeling) of coated surfaces it is known to use so-called soft-feel coatings particularly when used on plastic parts of automotive bodies and industrial applications. When soft-feel coatings are applied to interior surfaces of, for example, plastic or wooden parts, such as instrument panels, airbag covers, arm rests or interior door panels, they provide a soft or leather-like feel to the surfaces of these substrates. Soft-feel coatings are particularly based on solvent-borne and/or water-borne coating compositions based on particularly polyurethane resins, see, for example, EP-A 1481998.

One of the disadvantages of these coatings is that they do not possess good suntan cream resistance. Suntan cream can penetrate through the coatings and cause delamination of the coating from the substrate.

U.S. Pat. No. 5,880,215 discloses a paint formulation based on polyurethane dispersions in combination with polyester based polyisocyanates as component to improve the suntan cream resistance. In U.S. Pat. No. 6,927,254 the use of polycarbonate polyol based polyurethane is proposed to further improve the suntan lotion resistance.

The proposed coating compositions as known in the art and/or existing on the market may have a crosslinking density which is not high enough to ensure a sufficient suntan cream and solvent resistance. Furthermore, the goal to reduce the dry-film thickness of the coatings, due to ecological effects, cannot be achieved without losing desired coating properties.

Therefore, there is a need to provide improved coating compositions, which have sufficiently improved resistance to suntan lotion to pass the requirements of automotive manufacturers.

### SUMMARY OF THE INVENTION

This invention provides a coating composition providing a soft-feel effect and enhanced suntan cream resistance, the composition comprising
A) 5 to 50 wt %, preferably 20 to 40 wt %, of a dispersion and/or solution of at least one hydroxyl functional polyurethane, the dispersion and/or solution having a solids content in a range of 25 to 90 wt %, the wt % being based on the weight of the dispersion and/or solution,
B) 0 to 35 wt %, preferably 5 to 20 wt %, of at least one polyisocyanate as crosslinking agent,
C) 0.1 to 20 wt %, preferably 4 to 15 wt %, of at least one aqueous hydroxyl functional crosslinked (meth) acrylic latex,
D) 0 to 20 wt %, preferably 4 to 15 wt %, of organic solvent, and
E) 0.1 to 10 wt %, preferably 4 to 10 wt %, of at least one pigment, extender and/or coating additive,
the wt % being based on the total weight of the composition of A) to E).

The coating composition according to the invention provides coatings with significantly improved resistance to suntan creams or lotions without losing the good soft-feel effect of the coatings. The coating composition according to the invention makes it possible to reduce the dry-film thickness by keeping the above mentioned effects as well as further effects such as high solvent and abrasion resistance.

### DETAILED DESCRIPTION OF THE INVENTION

The features and advantages of the present invention will be more readily understood, by those of ordinary skill in the art, from reading the following detailed description. It is to be appreciated that those certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

Slight variations above and below the stated ranges can be used to achieve substantially the same results as values within the ranges. Also, the disclosure of these ranges is intended as a continuous range including every value between the minimum and maximum values.

The coating composition of this invention comprises as component A) a dispersion and/or solution of at least one hydroxyl functional polyurethane, in a range of 5 to 50 wt %, preferably 20 to 40 wt %, more preferably 20 to 36 wt %, the wt % based on the total weight of the composition of A) to E).

The dispersion and/or solution of the at least one hydroxyl functional polyurethane used in the invention may be produced, for example, by dispersing or dissolving or mixing the at least one polyurethane with a solvent and/or water, particularly deionized water, for example, by thorough dispersion of the optionally neutralized polyurethane with water. The aqueous phase optionally containing neutralizing agent may also initially be introduced and the polyurethane incorporated by stirring. Continuous processing is also possible, i.e., polyurethane, water and neutralizing agent can be simultaneously homogeneously mixed in known units, such as, for example, a rotor/stator mixer as known in the art. Conversion into the aqueous phase may also be promoted by using an elevated temperature, for example, in a range of 40 to 90° C.

The at least one hydroxyl functional polyurethane may be prepared, for example, by reacting linear or branched polyol components, for example diols, with one or more organic polyisocyanates, preferably diisocyanates, using known prior art methods.

The polyols comprise polyols familiar to the person skilled in the art, wherein proportions of polyols having a functionality of three or more may be added in order to achieve branching of the polymer. Suitable polyols are, for example, low molecular weight polyols, e.g., diols, triols, polyols, such as ethylene glycol, propandiol, 1,6-hexandiol, 1,2-cyclohexandiol, bisphenol A and mixtures thereof. Also diols derived from fatty alcohols can be used. Additional examples of polyols may be polyether polyols and polyester polyols. The polyether polyols may, for example, exhibit a general formula of HO—(CHR⁴)ₙ—ₘOH, in which R⁴ is hydrogen, C1 to C6 alkyl, optionally with various substituents, n=2 to 6 and m=10 to 50 or more, wherein the residues R⁴ may be identical or different. Polyester polyols may, for example, be produced by esterifying organic dicarboxylic acids or the anhydrides thereof with organic polyols. The dicarboxylic acids and polyols may be aliphatic, cycloaliphatic or aromatic dicarboxylic acids and polyols. The dicarboxylic acids may be long-chain dicarboxylic acids having 18 to 60 chain carbon atoms. The polyester polyols preferably have a number average molecular weight of 300 to 6000, an OH value of 20 to 400 and an acid value of <3, preferably of <1. Polycarbonate diols may also be used as polyols, also polyols derived from lactones. These products are obtained, for example, by reacting an epsilon-caprolactone with a diol, wherein these polylactone polyols are distinguished by the presence of a terminal hydroxyl group and by repeat polyester moieties derived from the lactone. The lactone may be any desired lactone or any desired combination of different lactones, for example, having 6 to 8 ring carbon atoms.

Additional compounds that are usable as polyol components are, for example, OH- and/or SH-containing polythioethers, OH-containing polyacetals, polyether-esters, OH-containing polyester-amides and polyamides, dihydroxypolyester carbonates, polyurethane diols, poly(meth)acrylate polyols, polybutanediene oil diols and hydroxy-functionalized siloxane copolymers. Linear polyester polyols and polyether polyols are preferably used.

As organic polyisocyanates, any aliphatic, cycloaliphatic or aromatic as well as sterically hindered isocyanates, which may for example also contain ether or ester groups, may be used, for example, diisocyanates. Polyisocyanates showing a higher isocyanate functionality than those described before, may also be used, e.g., polymeric polyisocyanates. Preferred isocyanates are those containing approximately 3 to approximately 36, particularly, approximately 8 to 15 carbon atoms. Examples of suitable diisocyanates are: hexamethylene diisocyanate, toluoylene diisocyanate, isophorone diisocyanate, hexane diisocyanate. Oligomeric diisocyanates are preferred.

Examples of hydroxyl functional polyurethanes are BAYHYDROL®LS 2244 and BAYHYDROL® LS 2305 of Bayer.

The hydroxyl functional polyurethanes are those, for example, with a number average molecular mass Mn of 1000 to 500 000 g/mol, preferably 5000 to 300 000 g/mol, an acid value of 10 to 100 mg KOH/g, preferably of 20 to 80 mg KOH/g, and a hydroxyl value of 0 to 400 mg KOH/g.

The term number average molar mass Mn stated in the present description means the number average molar mass determined or to be determined by gel permeation chromatography (GPC) with divinylbenzene crosslinked polystyrene as the immobile phase, tetrahydrofuran as the liquid phase and polystyrene standards, as defined in ISO 13885-1.

The various types of hydroxyl functional polyurethanes may be used alone or as a mixture of two or more thereof.

The term (meth) acryl is respectively intended to mean acryl and/or methacryl.

If the hydroxyl functional polyurethanes according to the invention contain groups that are capable of forming ions, said groups are entirely or in part converted into the corresponding salts using a suitable compound, for example, a neutralizing agent, as known at a person skilled in the art, wherein care must be taken to ensure that the compounds used for salt formation are selected such that they are chemically inert during synthesis. Ion-forming groups that may be present are those capable of forming anions or cations, as known by a person skilled in the art. Preferred are those groups capable of forming anions. In this case, a base, as known at a person skilled in the art, for example, NaOH, KOH, LiOH, ammonia, primary, secondary and tertiary amines such as diethylamine, triethylamine, morpholine; alkanolamines such as diisopropanolamine, dimethylaminoethanol, triisopropanolamine, dimethylamino-2-methylpropanol; quaternary ammonium hydroxides or also mixtures of such neutralising agents can be used for conversion into anions.

The hydroxyl functional polyurethanes usable according to the invention may be solvent-free or may be used dissolved or mixed in a solvent. Solvents that may be used are water-miscible solvents or water-immiscible solvents. Examples of suitable solvents are mono- or polyhydric alcohols, glycol ethers or esters, glycols, ketones, aromatic or aliphatic hydrocarbons, alkylpyrrolidones, ethers, and cyclic urea derivatives.

The solvent-free or solvent-containing hydroxyl functional polyurethane according to the invention may be converted into the aqueous phase by addition of sufficient quantities of water, particularly deionized water. A finely divided polyurethane dispersion and/or solution can then be obtained having an average particle size of, for example, >10 and <2000 nm, preferably in a range of 50 to 500 nm. The solids content of the dispersion and/or solution of the at least one hydroxyl functional polyurethanes is between 25 and 90 wt %, preferably above 35 to 60 wt %, based on the dispersion and/or solution of the at least one hydroxyl functional polyurethane.

The term average particle size mentioned in this document is respectively intended to mean the D90 value. The D90 value corresponds to a particle size below which 90 weight % of the particles lie, wherein the particle size analysis is done by PCS (Photon Correlation Spectroscopy) and meets the standards set forth in ISO 13321. Measurement is done on a Malvern Zetasizer 4000.

It is not generally necessary to use emulsifiers to convert the hydroxyl functional polyurethane into aqueous dispersions, but emulsifiers may nevertheless be used, in amounts known in the art. Examples of emulsifiers are ionic or nonionic emulsifiers that facilitate emulsification and optionally, reduce the number of ionizable groups.

Solvents optionally present in the polyurethane dispersion and/or solution according to the invention may, if desired, be removed by distillation, for example under reduced pressure.

The polyurethane dispersion and/or solution according to the invention may be self-crosslinked, physically dried or externally crosslinked by methods known in the art.

In case of self-crosslinkable polyurethane dispersion and/or solution the polyurethane contains crosslinkable functional groups known by a person skilled in the art. In this case, no crosslinking agent needs to be used in the composition according to the invention.

The coating composition according to the invention may contain at least one crosslinking agent as component B) for external crosslinking, in a range of 0 to 35 wt %, preferably 5 to 20 wt %, more preferably 5 to 17 wt %, the wt % based on the total weight of the composition of A) to E).

Various polyisocyanates, blocked or unblocked, may be used as crosslinking agents. Blocked polyisocyanates may be any desired polyisocyanates in which the isocyanate groups have been reacted with blocking agent(s) known in the art in such a manner that the resultant blocked polyisocyanate is resistant to hydroxyl groups and water at room temperature, but reacts at elevated temperatures, for example, in the range of 90 to 250° C. It is also possible to use unblocked polyisocyanates. Aliphatic, cycloaliphatic or aromatic as well as sterically hindered isocyanates may be used, as may also polyisocyanates, for example, diisocyanates, comprising ether or ester groups. Preferred isocyanates are those which contain approximately 3 to approximately 36, in particular, approximately 8 to 15 carbon atoms. Examples of suitable diisocyanates are hexamethylene diisocyanate, tolylene diisocyanate, isophorone diisocyanate, hexane diisocyanate. Oligomeric diisocyanates are preferred. Polyisocyanates of greater isocyanate functionality than those described above, as known in the art, for example, polymeric polyisocyanates, may also be used. The crosslinking agents may be used individually or as a mixture.

The coating composition according to the invention comprises at least one aqueous hydroxyl functional crosslinked (meth) acrylic latex as component C) in a range of 0.1 to 20 wt %, preferably 4 to 15 wt %, more preferably 4 to 12 wt %, the wt % based on the total weight of the composition of A) to E).

The term aqueous hydroxyl functional crosslinked (meth)acrylic latex is respectively intended to mean water-dispersed (meth)acrylic emulsion polymer, i.e. water-dispersed polymer particles prepared by emulsion polymerizing free-radically polymerizable olefinically unsaturated (meth)acrylic monomers optionally in combination with other free-radically polymerizable olefinically unsaturated monomers.

The at least one aqueous hydroxyl functional crosslinked (meth) acrylic latex can be prepared by multistage emulsion polymerization in the aqueous phase, comprising the steps:
1) free-radical polymerization of a mixture A1 of olefinically unsaturated, free-radically polymerizable monomers, optionally comprising at least one monomer with at least one acid group and at least one olefinically polyunsaturated monomer, in the aqueous phase,
2) free-radical polymerization of at least one mixture B1 of olefinically unsaturated, free-radically polymerizable monomers, optionally comprising at least one monomer with at least one acid group and at least one olefinically polyunsaturated monomer in the presence of the product obtained in process step 1),
   wherein the ratio by weight of mixture A1 to the at least one mixture B1 is from 15:85 to 85:15 and wherein mixture A1 or the at least one mixture B1 or both mixture A1 and the at least one mixture B1 comprise the at least one monomer with at least one acid group and wherein mixture A1 or the at least one mixture B1 or both mixture A1 and the at least one mixture B1 comprise the at least one olefinically polyunsaturated monomer.

Preferably, mixture A1 comprises at least one monomer with at least one acid group in a proportion corresponding to an acid value of mixture A of 10 to 100 mg of KOH/g and 0.5 to 5 wt % of at least one olefinically polyunsaturated monomer.

Preferably, mixture B1 comprises at least one monomer with at least one acid group in a proportion corresponding to an acid value of mixture B1 of 0 to below 5 mg of KOH/g, at least one monomer with at least one hydroxyl group in a proportion corresponding to a hydroxyl value of mixture B1 of 0 to below 5 mg of KOH/g and at least one olefinically polyunsaturated monomer in a proportion of 0.5 to 5 wt. %, relative to mixture B1.

The aqueous hydroxyl functional crosslinked (meth) acrylic latex is produced by a multistage, preferably two-stage emulsion polymerization, i.e. the mixtures A1 and B1 of olefinically unsaturated monomers to be free-radically polymerized are polymerized under conventional conditions known to the person skilled in the art of a free-radical polymerization performed in an aqueous emulsion, i.e. using one or more emulsifiers and with the addition of one or more initiators which are thermally dissociable into free radicals. In order to ensure the formation of a crosslinked or even gel structure in the polymer products formed in at least one of the stages of the emulsion polymerization, olefinically polyunsaturated monomers are used and copolymerized.

Examples of olefinically unsaturated, free-radically polymerizable monomers with at least one acid group are in particular olefinically unsaturated monomers containing carboxyl groups, such as, for example, (meth)acrylic, itaconic, crotonic, isocrotonic, aconitic, maleic and fumaric acid, semi-esters of maleic and fumaric acid and carboxyalkyl esters of (meth)acrylic acid, for example, beta-carboxyethyl acrylate and adducts of hydroxyalkyl(meth)acrylates with carboxylic anhydrides, such as, for example, phthalic acid mono-2-(meth)acryloyloxyethyl ester. (Meth)acrylic acid is preferred.

Examples of olefinically polyunsaturated, free-radically polymerizable monomers are divinylbenzene, hexanediol di(meth)acrylate, ethylene and propylene glycol di(meth)acrylate, 1,3- and 1,4-butanediol di(meth)acrylate, vinyl(meth)acrylate, allyl(meth)acrylate, diallyl phthalate, glycerol tri(meth)acrylate, trimethylolpropane tri(meth)acrylate, pentaerythritol tetra(meth)acrylate, di- and tripropylene glycol di(meth)acrylate, hexamethylene bis(meth)acrylamide. Further examples are compounds which may be produced by a condensation or preferably by an addition reaction of complementary compounds, which in each case, in addition to one or more olefinic double bonds, contain one or more further functional groups per molecule. The further functional groups of the individual complementary compounds comprise pairs of mutually complementary reactive groups, in particular groups which are capable of reacting with one another for the purposes of a possible condensation or addition reaction.

Examples of olefinically polyunsaturated, free-radically polymerizable monomers produced by a condensation reaction are reaction products formed from alkoxysilane-functional (meth)acrylic monomers after hydrolysis with elimination of alcohol and formation of siloxane bridges. Further examples are reaction products formed from hydroxyalkyl(meth)acrylates and olefinically unsaturated isocyanates blocked on the isocyanate group, such as isocyanatoalkyl(meth)acrylate or m-isopropenyl-alpha,alpha-dimethylbenzyl isocyanate with elimination of the blocking agent and formation of urethane groups.

Examples of olefinically polyunsaturated, free-radically polymerizable monomers produced by an addition reaction are addition products formed from hydroxyalkyl(meth)acrylates and olefinically unsaturated isocyanates, such as isocyanatoalkyl(meth)acrylate or m-isopropenyl-alpha,alpha-dimethylbenzyl isocyanate with formation of a urethane group or reaction products formed by ring-opening addition of the epoxy group of unsaturated epoxy compounds onto the carboxyl group of an unsaturated acid with formation of an ester group and a hydroxyl group, such as, for example, the addition product formed from glycidyl (meth)acrylate and (meth)acrylic acid.

Apart from the at least one olefinically unsaturated, free-radically polymerizable monomer with at least one acid group and the at least one olefinically polyunsaturated, free-radically polymerizable monomer, mixture A1 and the at least one mixture B1 also comprise one or more further olefinically unsaturated, free-radically polymerizable monomers. These may comprise functional groups or they may be non-functionalized and they may also be used in combination.

Examples of olefinically unsaturated, free-radically polymerizable monomers without functional groups usable in mixture A1 are monovinyl aromatic compounds such as styrene, vinyltoluene; vinyl ethers and vinyl esters, such as vinyl acetate, vinyl versatate; maleic, fumaric, tetrahydrophthalic acid dialkyl esters; but in particular (cyclo)alkyl (meth)acrylates, such as methyl(meth)acrylate, ethyl(meth)acrylate, propyl(meth)acrylate, butyl(meth)acrylate, isobutyl(meth)acrylate, tert.-butyl (meth)acrylate, hexyl(meth)acrylate, cyclohexyl(meth)acrylate, ethylhexyl(meth)acrylate, decyl(meth)acrylate, dodecyl(meth)acrylate, hexadecyl(meth)acrylate, lauryl(meth)acrylate and isobornyl (meth)acrylate.

Examples of olefinically unsaturated, free-radically polymerizable monomers with functional groups which may be mentioned are in particular olefinically unsaturated monomers with at least one hydroxyl group, such as allyl alcohol, but in particular hydroxyalkyl(meth)acrylates such as, for example, hydroxyethyl(meth)acrylate, and the hydroxypropyl (meth)acrylates, hydroxybutyl(meth)acrylates isomeric with regard to the position of the hydroxyl group. Further examples are glycerol mono(meth)acrylate, adducts of (meth)acrylic acid onto monoepoxides, such as, for example, versatic acid glycidyl ester and adducts of glycidyl (meth)acrylate onto monocarboxylic acids such as, for example, acetic acid or propionic acid.

The duration of the emulsion polymerization (time taken to apportion mixtures A1 and B1 into the aqueous initial charge plus the duration of the neutralization operation plus the duration of the post-polymerization phase) is, for example, 1 to 10 hours. The polymerization temperature in the aqueous phase is, for example, 50 to 95° C.

The emulsifier(s) is/are used in a conventional total quantity of, for example, 0.1 to 3 wt %, relative to the sum of the weights of mixtures A1 and B1 and may be initially introduced and/or added as a constituent of the mixtures A1 and B1 and/or added in parallel to the addition of mixtures A1 and B1. Examples of usable emulsifiers are the conventional cationic, anionic and nonionic emulsifiers usable in the context of emulsion polymerization, such as, for example, cetyltrimethylammonium chloride, benzyldodecyldimethylammonium bromide, sodium dodecyl sulfate, sodium dodecylbenzenesulfonate, polyethylene glycol monolauryl ether. Care must be taken to ensure that cationic and anionic emulsifiers are not used with one another.

The initiator(s) which are thermally dissociable into free radicals (free-radical initiators) are used in a conventional total quantity of, for example, 0.02 to 2 wt %, relative to the sum of the weights of mixtures A1 and B1 and are added contemporaneously with the addition of mixtures A1 and B1. Water-soluble free-radical initiators may be added as such, as a constituent of mixtures A1 and B1, but in particular as an aqueous solution. A portion of the free-radical initiators may, however, be initially introduced and/or added once addition of the monomers is complete. The free-radical initiators are preferably water-soluble. Examples of usable free-radical initiators are hydrogen peroxide, peroxodisulfates, ammonium salts of 4,4′-azobis(4-cyanopentanoic acid), 2,2′-azobis(2-methyl-N-1,1-bis(hydroxymethyl)ethyl)propionamide, 2,2′-azobis(2-methyl-N-2-hydroxyethyl)propionamide as well as conventional redox initiator systems known to the person skilled in the art.

The monomer mixtures A1 and B1 according to process steps 1) and 2) are added, as usually done in emulsion polymerizations, into an aqueous initial charge, which has generally already been adjusted to the polymerization temperature. Process steps 1) and 2) consequently comprise the addition of mixtures A1 and B1. Mixtures A1 and B1 are added one after the other according to process steps 1) and 2), wherein the addition of the one or more mixtures B1 is begun with process step 2), but at the earliest after completion of process step 1, and in the most preferred embodiment, at the earliest once at least 90 wt % of the monomers of mixture A1 have been polymerized and the neutralization according to process step 1a) has been performed. The extent to which the polymerization has been taken to completion may readily be determined by determining the solids content. The addition of the at least one mixture B1 into the aqueous initial charge may thus begin in case of the most preferred embodiment at the earliest after the polymerization of 90% of mixture A1 and the subsequent addition of the neutralizing agent in process step 1, which corresponds to the case of a very high rate of polymerization with virtually instantaneous 100% polymerization conversion. In general, however, mixture A1 is initially added in its entirety during process step 1), after which the neutralizing agent can be added once the mixture A1 monomers have been at least 90%, preferably completely, polymerized and only thereafter, during process step 2), is the at least one mixture B1 added.

The acid groups of the polymer obtained in process step 1) and/or in process step 2) are neutralized using conventional basic neutralizing agents, such as ammonia and in particular amines and/or aminoalcohols such as, for example, triethylamine, dimethylisopropylamine, dimethylethanolamine, dimethylisopropanolamine and 2-amino-2-methyl-1-propanol.

The basic neutralizing agents are added in accordance with a degree of neutralization of, for example, 10 to 100%. A degree of neutralization of 100% here corresponds to a stoichiometric neutralization of each acid group in the polymer arising from mixture A1 and/or B1. For example, the degree of neutralization is selected dependent on the solids content of the aqueous binder latex obtained after completion of the process and also dependent on the acid value of the corresponding monomer mixture. In general, a low degree of neutralization is selected in the case of elevated acid values and elevated solids content and vice versa.

The term “mixture” used in connection with mixtures A1 and B1 does not exclude separate addition of the particular monomers, i.e. the monomers may also be added individually or as two or more different mixtures of only some of the monomers. It is preferred, however, to add separate mixtures A1 and B1. Mixtures A1 and B1 may also be added in the form of pre-emulsions.

The ratio by weight of mixture A1 to the at least one mixture B1 is 15:85 to 85:15.

The polymerization process described above permits the production of aqueous hydroxyl functional crosslinked (meth) acrylic latices with solids contents of, for example, 30 to 60 wt. %.

The average particles size of the can be in the range of the solids in the aqueous hydroxyl functional crosslinked (meth) acrylic lattices can be in the range of preferably 30 to 500 nm.

The coating composition according to the invention may comprise solvents as component D) in a range of 0 to 20 wt %, preferably 4 to 15 wt %, most preferably 4 to 12 wt %, the wt % based on the total weight of the composition of A) to E). Suitable solvents that may be present are conventional coating solvents, which may originate from production of the polyurethane or are added separately. Examples of such solvents are those as mentioned above. The flow and viscosity of the coating composition may be influenced by selection of the solvents, while the evaporation behavior of the coating composition may be influenced by the boiling point of the solvent mixture used.

The coating composition according to the invention comprises at least one pigment, extender and/or coating additive as component E) in a range of 0.1 to 10 wt %, preferably 4 to 10 wt %, more preferably 4 to 8 wt %, the wt % based on the total weight of the composition of A) to E).

Examples of pigments are colour-imparting and/or special effect-imparting pigments. Suitable colour-imparting pigments are any conventional coating pigments of an organic or inorganic nature considering their stability within the coating composition of the invention and also regarding the withstanding of the curing conditions of the composition of the invention. Examples of inorganic or organic colour-imparting pigments are titanium dioxide, micronized titanium dioxide, carbon black, iron oxide, azo pigments, and phthalocyanine pigments. Examples of special effect-imparting pigments are metal pigments, for example, made from aluminium, copper or other metals, interference pigments, such as, metal oxide coated metal pigments and coated mica.

Examples of usable extenders are silicon dioxide, aluminium silicate, barium sulfate, calcium carbonate, magnesium carbonate and micronized dolomite, as known in the art.

The pigments can be incorporated into the coating composition using conventional methods. Special effect-imparting pigments can be incorporated, for example, in the form of a conventional commercial aqueous or non-aqueous paste. Colour-imparting pigments or extenders can be incorporated, for example, with grinding in a proportion of the aqueous polyurethane, wherein grinding may also be performed in a special, water-dilutable paste resin.

Examples of coating additives are the common known coating additives such as levelling agents, rheological agents such as highly dispersed silica or polymeric urea compounds, thickeners, defoamers, wetting agents, anticratering agents, degassing agents, thermolabile initiators, antioxidants and light stabilizers based on HALS (hindered amine light stabilizer) products, tribo-charging agents, accelerators, initiators, inhibitors and catalysts.

Catalysts may optionally be used to accelerate curing. It is, however, also possible to cure with thermal energy without using a catalyst.

The coating composition according to the invention may also contain one or more additional binders. This may be advantageous, for example, in order to achieve certain synergistic effects. Examples of additional binders are the conventional film-forming resins familiar to the person skilled in the art, for example in a range of 0 to 20 wt %, based on the total weight of the composition of A) to E). Preferably, no such additional binders are used.

The coating composition of this invention comprising the components A) to E) may be prepared in such a manner that the components A) and C) to E) are mixed together under addition of deionized water to provide a solids content in a range of 30 to 40%, preferably 34 to 38%, based on the components A) and C) to E). This mixture can then be combined with the component B) in a ratio in a range of 90:10 to 70:30, based on the total weight of the composition.

The coating material according to the invention may be applied using conventional methods, preferably being applied by spraying to a dry film thickness of 8 to 500 μm, preferably 8 to 50 μm, more preferably 15 to 35 μm. Application is preferably performed using the wet-on-wet process with drying or crosslinking at temperatures, for example, of 20 to 140° C., object temperature in each case, as generally known in the art.

The applied coating composition can be dried or cured by thermal energy. The coating layer may, for example, be exposed to convective, gas and/or radiant heating, e.g., infra red (IR) and/or near infra red (NIR) irradiation, as known in the art. If the coating composition contains unsaturated resins and, optionally, photo-initiators the curing process can be done by a polymerisation step by irradiation with high energy such as ultra violet (UV) or electron beam (EB) radiation. If the coating composition contains resins having thermally reactive functions together with resins having unsaturated functions, dual curing may be used which means a combination of curing with high energy irradiation and thermal curing, with methods described above.

The coating composition according to the invention may be used in multi-layer coatings. The coating composition of this invention may be used as a clear coat with or without the use of transparent pigments.

The multi-layer coatings may be applied onto the substrates in various manners. Plastic substrates may, for example, be provided with a plastic primer, onto which the coating composition according to the invention is applied and cured. The coating composition according to the invention may also be applied wet-on-wet onto uncrosslinked filler layers and then be cured together with the filler layer.

It is also possible to apply the coating composition according to the invention directly without further inter-layers, onto the substrate, as one-layer coating.

The coating composition according to the invention may also be used as an aqueous top coat in multi-layer coatings, for example, applied onto a color-imparting base coat. Suitable base coats are in principle any known base coats. Not only solvent-containing one- or two-component coating compositions, but also water-dilutable base coats or radiation-curable base coats may be used. Such multilayer coatings may likewise be applied onto the substrates in various manners. Plastic substrates may be provided with a plastic primer, onto which the base coat layer is applied and cured. The base coat may also be applied wet-on-wet onto uncrosslinked filler coats, then cured together with the filler coat, generally prior to application of a clear top coat, whereupon the coating composition according to the invention may then be applied and cured.

Suitable substrates for coating with the coating composition according to the invention are substrates made from metal, plastics, concrete, wood and films (plastic films, paper sheets), in particular, plastic industrial and automotive parts, in particular, plastic parts for interiors.

The invention furthermore relates to a substrate coated with the coating composition according to the invention optionally in conjunction with a multilayer system, and drying or curing of the coating on the substrate.

The multi-layer system may be obtained by applying at least one primer coat, preferably based on a water-dilutable coating composition, applying a conventional color-imparting base coat layer, optionally drying the base coat and applying a transparent coating composition comprising the coating composition according to the invention as the top coat and subsequently heating the coated substrate. Further, additional layers may optionally be added to this multi-layer coating. The primer coat may also be omitted.

The multi-layer coating according to the invention exhibits a good surface with very good interlayer adhesion. In particular, using the coating composition according to the invention it is possible to achieve a surface finish with a pleasantly soft appearance (soft-feel effect).

Substrates coated with the coating composition according to the invention may be used for the most varied purposes. For example, it is possible to use the process according to the invention to coat substrates that are used for insulation purposes, i.e. for acoustic as well as thermal insulation. The composition according to the invention may furthermore be used to equip the substrates in accordance with various requirements with regard to acoustic properties, for example in order to achieve certain acoustic behaviour. Finally, the process according to the invention may be used to provide an attractive, decorative finish on substrate surfaces and to achieve certain tactile properties, for example, a soft appearance. The substrates coated using the process according to the invention are readily cleanable and are very durable, i.e. exhibit an extended service life of the coating while retaining the desired properties.

The following example illustrates the invention. It should be understood that these Examples are given by way of illustration only.

### EXAMPLES

### Example 1

### Preparation of a Coating Composition of the Invention

1.1:
To 20 parts per weight of OH-functional polyurethane dispersion (BAYHYDROL® LS 2244/1) 4 parts per weight of silica dioxide, 2.5 parts per weight of wetting agent and solvent are added while stirring. An amount of trialkylamine is added to the mixture to provide a pH value of 8 to 8.2, and deionized water is added to provide the solids content of 36 to 40% of the resulted aqueous mixture. The resulted mixture is dispersed until a particle size of 15 to 20 μm is received.
1.2:
To 66 parts per weight of the above resulted aqueous mixture 8 parts per weight of the hydroxyl functional crosslinked (meth) acrylic latex, 2 to 3 parts per weight of wetting agent and pigments prepared as paste are added. An amount of trialkylamine is added to the mixture to provide a pH value of 8 to 8.2, and deionized water is added to provide the solids content of 34 to 38% of the resulted aqueous mixture.

Exactly before the application process, 17 wt % of a HDI-solution (hexamethylene diisocyanate solution) as curing agent (solids content: 50 to 52 wt %) are added to the above prepared aqueous dispersion for homogenization within 10 minutes at 1000 rpm.

### Example 2

### Coating Composition of Prior Art

To 66 parts per weight of the resulted aqueous mixture under Example 1.1 a polyester urethane dispersion (BAYHYDROL® LP RSC 1187) is added in an amount of 8 parts per weight, and further 2 to 3 parts per weight of wetting agent and pigments prepared as paste are added. The coating composition is then prepared in the same way as described under Example 1.2.

### Example 3

### Application and Tests

The application process takes place by means of 3 to 4 cross-coat spraying steps on a plastic surface with a dry-film thickness of 20 to 25 μm (dry-film thickness according to DIN EN ISO 2178 for metal surfaces and comparison with the dry-film thickness on the plastic surface).
The test results can be seen in Table 1.

TABLE 1

| | Adhe- | | Suntan | Suntan | | |
|---|---|---|---|---|---|---|
| | sion | | Cream 1 | Cream 2 | | |
| | Cross | | (LSF 30) | (LSF 45) | | Abrasion |
| | Cut | Soft | Scratch | Scratch | Hydrolysis | Resistance |
| | DIN | Appea- | Resis- | Resis- | 72 h at 90 | (Crock- |
| Coating | EN | rance | tance | tance | +/− 2° C. | meter) |
| Compo- | ISO | (Haptic- | DIN EN | DIN EN | 96% rel. | DIN EN 20 |
| sition | 2409 | visually) | ISO 1518 | ISO 1518 | humidity | 105-A03 |
| Example | 0 | O.K. | O.K. | O.K. | Scratch | 2 |
| 1 | | | | | Resistance | |
| | | | | | DIN EN | |
| | | | | | ISO | |
| | | | | | 1518: O.K. | |
| Example | 0 | O.K. | not O.K | not O.K. | Scratch | 1 |
| 2 | | | | | Resistance | |
| | | | | | DIN EN | |
| | | | | | ISO | |
| | | | | | 1518: O.K. | |

What is claimed is:

1. A coating composition comprising
A) 5 to 50 wt % of an dispersion and/or solution of at least one hydroxyl functional polyurethane, the dispersion and/or solution having a solids content in a range of 25 to 90 wt %, the wt % being based on the weight of the dispersion and/or solution,
B) 0 to 35 wt % of at least one polyisocyanate as cross-linking agent,
C) 0.1 to 20 wt % of at least one aqueous hydroxyl functional crosslinked (meth) acrylic latex,
D) 0 to 20 wt % of organic solvent, and
E) 0.1 to 10 wt % of at least one pigment, extender and/or coating additive,
the wt % being based on the total weight of the composition of A) to E).

2. The coating composition of claim 1 comprising
A) 20 to 40 wt % of an dispersion and/or solution of at least one hydroxyl functional polyurethane, the dispersion and/or solution having a solids content in a range of 25 to 90 wt %, the wt % being based on the weight of the dispersion and/or solution,
B) 5 to 20 wt % of at least one polyisocyanate as cross-linking agent,
C) 4 to 15 wt % of at least one aqueous hydroxyl functional crosslinked (meth) acrylic latex,
D) 4 to 15 wt % of organic solvent, and
E) 4 to 10 wt % of at least one pigment, extender and/or coating additive,
the wt % being based on the total weight of the composition of A) to E).

3. A coated substrate coated with the coating composition of claims 1 and 2.
